(19) United States
(12) Patent Application Publication
(10) Pub. No.: US 2021/0104712 A1
(43) Pub. Date: Apr. 8, 2021

(54) BATTERY PACK AND ELECTRONIC APPARATUS

(71) Applicant: SHARP KABUSHIKI KAISHA, Sakai City (JP)

(72) Inventors: JUNYA TAKAHASHI, Sakai City (JP); SHINJI HAIGAKI, Sakai City (JP)

(21) Appl. No.: 17/037,678

(22) Filed: Sep. 30, 2020

(30) Foreign Application Priority Data
Oct. 7, 2019 (JP) 2019-184255

(51) Int. Cl. H01M 2/10

(52) U.S. Cl. CPC H01M 2/1066; H01M 2220/30; H01M 2/1055

(57) ABSTRACT

A battery pack includes: a battery main body including a battery element and an external laminate packaging body packaging the battery element, the battery main body having two opposing main faces and an end face connecting the two opposing main faces; a circuit board disposed external to the end face and electrically connected to the battery main body; and a holder section configured to hold the circuit board, wherein the circuit board has an electronic component mounting surface inclined with respect to the two opposing main faces in a cross section of the battery main body taken parallel to a plane perpendicular to the two opposing main faces.

### CROSS-REFERENCE TO RELATED APPLICATIONS

The present application claims priority from Japanese Application JP2019-184255, the content to which is hereby incorporated by reference into this application.

### BACKGROUND OF THE INVENTION

### 1. Field of the Invention

The present invention relates to battery packs and electronic apparatus.

### 2. Description of the Related Art

Smartphones, which are a type of electronic apparatus, use a large-capacity lithium polymer battery for extended operation time. The lithium polymer battery disclosed in Japanese Unexamined Patent Application Publication, Tokukai, No. 2018-200761 includes: a laminate-covered cell; a circuit board; and a flexible substrate connecting the circuit board to the main substrate of the smartphone. The cell has, on an end portion thereof, a plurality of projecting output terminals connected to the circuit board. The lithium polymer battery is structured such that the circuit board has an edge portion thereof covered with an adhesive film with the edge portion being positioned opposite an end portion of the cell.

### SUMMARY OF THE INVENTION

The lithium polymer battery has a risk of breaking the battery due to an impact, for example, when the smartphone is dropped because the circuit board may damage the laminate-covered cell. The present invention, in an aspect thereof, has an object to provide a battery pack and electronic apparatus that are less prone to damage.

(1) The present invention, in an aspect thereof, is directed to a battery pack including: a battery main body including a battery element and an external laminate packaging body packaging the battery element, the battery main body having two opposing main faces and an end face connecting the two opposing main faces; a circuit board disposed external to the end face and electrically connected to the battery main body; and at least one holder section configured to hold the circuit board, wherein the circuit board has an electronic component mounting surface inclined with respect to the two opposing main faces in a cross section of the battery main body taken parallel to a plane perpendicular to the two opposing main faces.

(2) In an aspect of the present invention, the battery pack is configured such that the at least one holder section holds the circuit board in such a manner that when the battery main body is displaced into contact with the circuit board, the circuit board is displaced in accordance with the displacement of the battery main body.

(3) In an aspect of the present invention, the battery pack is configured so as to further include a film configured to secure the battery main body, the circuit board, and the at least one holder section.

(4) In an aspect of the present invention, the battery pack is configured such that the at least one holder section includes a plurality of holder sections.

(5) The present invention, in an aspect thereof, is directed to an electronic apparatus including: the battery pack of any one of aspects (1) to (4); and a housing including a battery enclosure configured to enclose the battery pack.

### BRIEF DESCRIPTION OF THE DRAWINGS

FIG. 1 is a front view of a smartphone in accordance with an embodiment of the present disclosure.

FIG. 2 is a front view of a structure inside a housing with a display unit being removed from the smartphone.

FIG. 3 is a cross-sectional view taken along line III-III in FIG. 2.

FIG. 4 is a front view of a battery pack.

FIG. 5 is a rear view of the battery pack.

FIG. 6A is a cross-sectional view of major components of the battery pack, and FIG. 6B is a perspective view of a holder section.

FIG. 7 is a side view of changes caused by external impact in a circuit board of the battery pack.

FIG. 8A is a cross-sectional view of major components of a battery pack in accordance with Variation Example 1, and FIG. 8B is a perspective view of a holder section in accordance with Variation Example 1.

FIG. 9A is a cross-sectional view of major components of a battery pack in accordance with Variation Example 2, and FIG. 9B is a perspective view of a holder section in accordance with Variation Example 2.

FIG. 10A is a cross-sectional view of major components of a battery pack in accordance with Variation Example 3, and FIG. 10B is a perspective view of a holder section in accordance with Variation Example 3.

FIG. 11 is a cross-sectional view of another battery pack.

### DETAILED DESCRIPTION OF THE INVENTION

### Embodiments

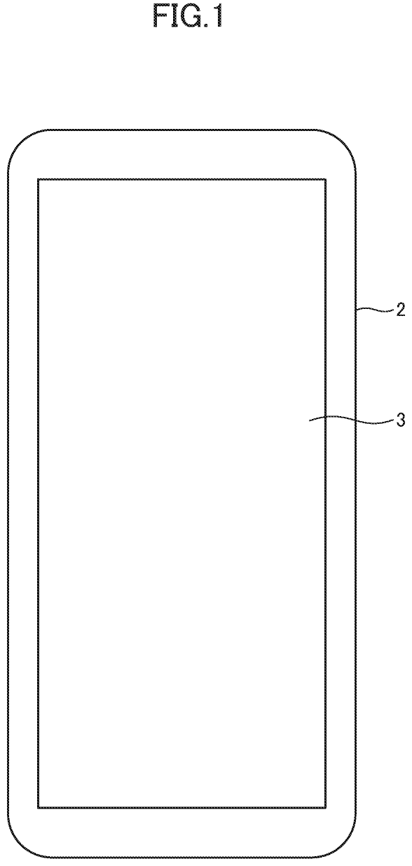

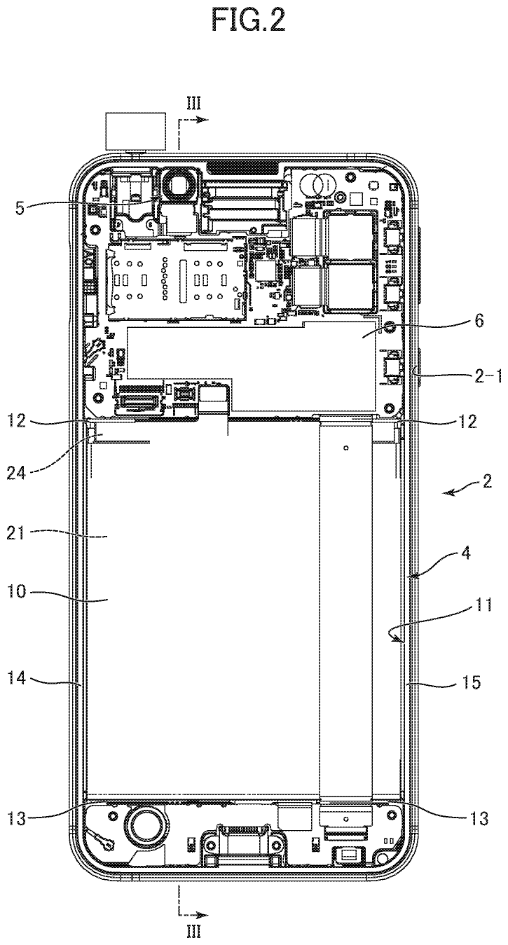

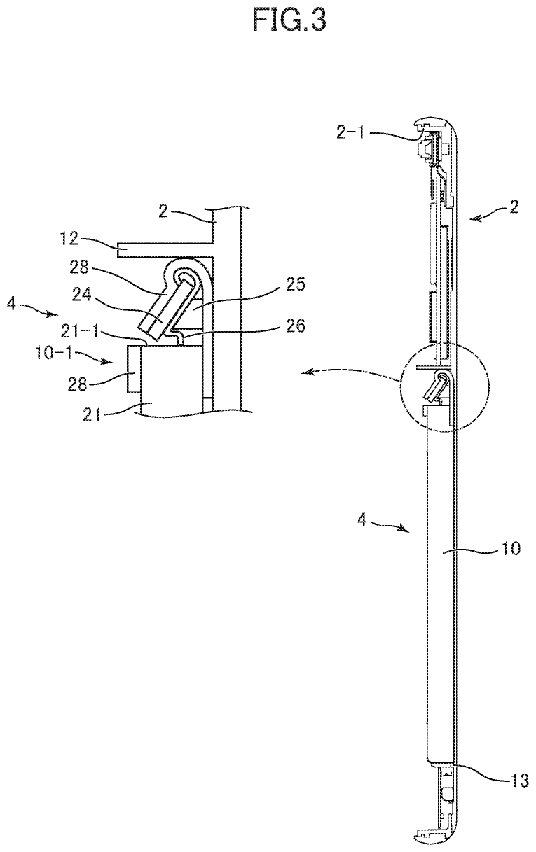

The following will describe, with reference to drawings, embodiments of the present disclosure where the present invention is applied, as an example, to a smartphone which is an example of electronic apparatus. The present invention is however applicable not only to smartphones, but also to any electronic apparatus. FIG. 1 is a front view of a smartphone in accordance with an embodiment of the present disclosure. FIG. 2 is a front view of a structure inside a housing with a display unit being removed from the smartphone. FIG. 3 is a cross-sectional view taken along line III-Ill in FIG. 2. Throughout the following embodiments, the front side of the display unit of the smartphone will be referred to as the “front,” the rear side thereof as the “rear,” the upper side thereof with respect to the up/down direction as the “top,” the lower side thereof as the “bottom,” the left side with respect to the left/right direction as the display unit is viewed from the front side as the “left,” and the right side thereof as the “right,” for convenience of description.

Referring to FIG. 1, a smartphone 1 is a thin electronic apparatus that has a generally rectangular shape when viewed from the front. The smartphone 1 contains, inside a housing 2, a plurality of electronic components including: a display unit 3; a speaker (not shown); a microphone (not shown); an image capturing unit 5 shown in FIG. 2; a card connector (not shown); a main circuit board 6 for controlling the operation of these components; and a battery pack 10.

The display unit 3 displays images and is additionally equipped with a touch panel, as an input device, providing a user interface for the smartphone 1.

Referring to FIGS. 2 and 3, the housing 2 is shaped like such a generally rectangular frame that the display unit 3 can be attached on the front thereof. The housing 2 has a forward projecting, wall-shaped sidewall portion 2-1 along the periphery thereof.

The housing 2 contains, in the internal central part thereof, a generally rectangular, concave battery enclosure 4 which forms a rearward concavity. The battery enclosure 4 is surrounded by a generally frame-shaped partition wall section 11 projecting forward toward the display unit 3.

The generally frame-shaped partition wall section 11 includes partitioning bodies 12, 12, 13, 13 on the respective top and bottom corners thereof and partitioning bodies 14, 15 extending in the up/down direction on the left and right sides thereof. The battery enclosure 4 contains the battery pack 10 which is flat and generally rectangular (described later in detail). The partitioning bodies 12, 12, may include an elastic body for absorbing external impact. A circuit board 24 of the battery pack 10 has a longer side thereof in contact with the partitioning bodies 12, 12.

The internal upper part of the housing 2, above the battery enclosure 4, contains the main circuit board 6 carrying thereon various circuit components of a power supply circuit, a control circuit, and a communications circuit as well as those of a card connector and the image capturing unit 5. The internal lower part of the housing 2, below the battery enclosure 4, contains a sub-circuit board carrying electronic components thereon.

The housing 2 may additionally include a cover sheet (not shown) for securing the battery pack 10 in the battery enclosure 4. The cover sheet has an adhesive surface across one of the faces thereof, so that the battery pack 10 can be securely attached to the adhesive surface. The cover sheet is composed at least primarily of a general purpose, flame-retardant plastic such as PET (polyethylene terephthalate).

The image capturing unit 5 includes, for example: an imaging device for capturing still and moving images; and a processing circuit.

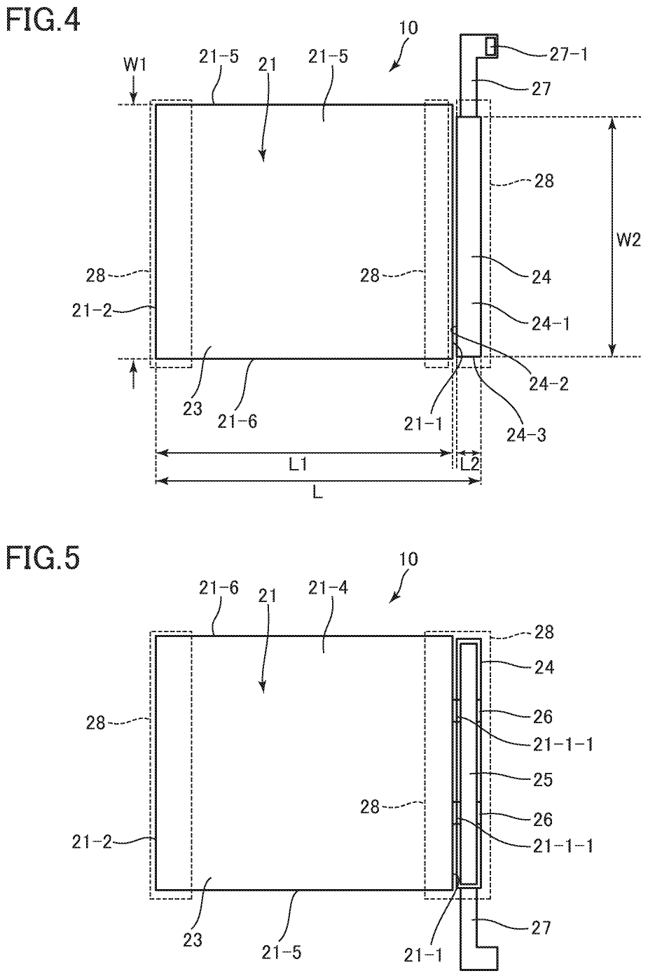

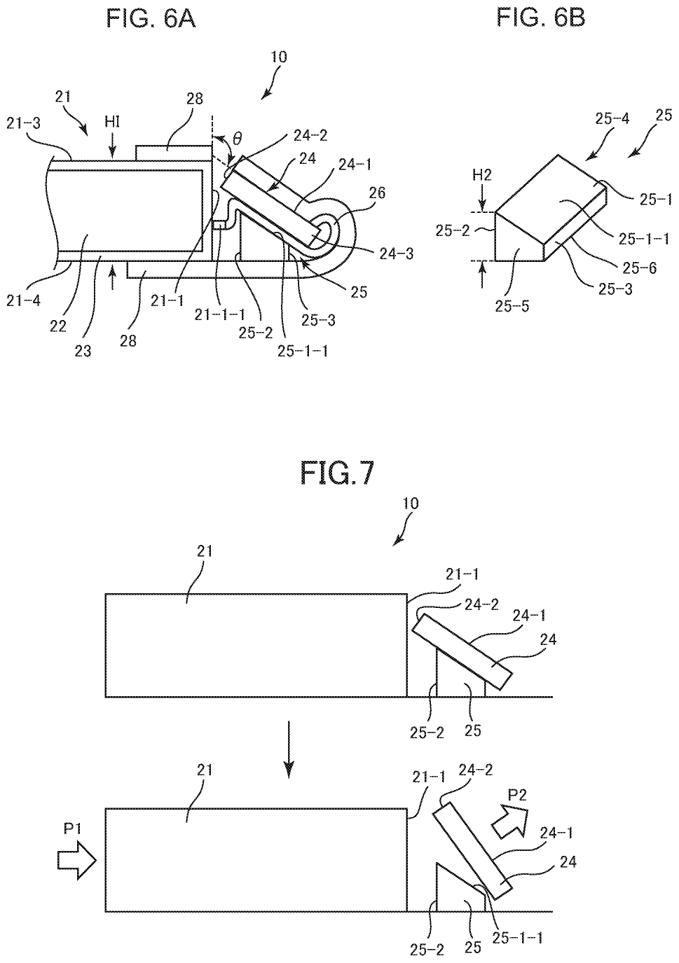

A description will be given next of the structure of the battery pack 10. FIG. 4 is a front view of a battery pack. FIG. 5 is a rear view of the battery pack. FIG. 6A is a cross-sectional view of major components of the battery pack, and FIG. 6B is a perspective view of a holder section.

Referring to FIGS. 4 and 5, the battery pack 10 is a pouch or laminate packaged battery fabricated by enclosing, for example, a lithium-ion polymer battery element 22 in a flexible external laminate packaging body 23. Specifically, as shown in FIG. 6A, the battery pack 10 includes a battery main body 21, the circuit board 24, and a holder section 25. The battery main body 21 has two opposing main faces and an end face connecting the two opposing main faces. The battery element 22 is packaged in the external laminate packaging body 23. The circuit board 24 is positioned outside the battery main body 21, facing the end face, and is electrically connected to the battery main body 21. The holder section 25 holds the circuit board 24. The circuit board 24 has an electronic component mounting surface 24-1 that is inclined with respect to the two opposing main faces in a cross section of the battery main body 21 taken parallel to a plane perpendicular to the two opposing main faces.

In the battery pack 10, the circuit board 24 is placed on a tapered surface 25-1-1 of the holder section 25 in such a manner that the electronic component mounting surface 24-1 of the circuit board 24 makes an obtuse angle θ with an end face of an end portion 21-1 of the battery main body 21. Additionally in the battery pack 10, the circuit board 24 and the holder section 25 are attached close to the end portion 21-1 of the battery main body 21. The battery main body 21 includes output sections 21-1-1 electrically connected to the circuit board 24 via wiring 26. Specifically, the wiring 26, connected to the output sections 21-1-1 of the battery main body 21, is routed between the holder section 25 and the circuit board 24 on the tapered surface 25-1-1, folded back from an end of the tapered surface 25-1-1, and connected to the mounting surface of the circuit board 24. The battery pack 10 is fabricated by covering (hence securing) the battery main body 21, the circuit board 24, and the holder section 25 with an adhesive film 28. The wiring 26, connected to the output sections 21-1-1 of the battery main body 21, may alternatively be routed on the bottom face of the holder section 25 and connected to the circuit board 24.

A description will be given next of the components of the battery pack 10. The external laminate packaging body 23 is a thin film for enveloping the battery element 22 and composed, for example, of an aluminum laminate film shaped like a bag.

The battery element 22 includes a lithium-ion polymer electrolyte gel and a positive terminal electrode and a negative terminal electrode. The electrolyte is prepared by impregnating an electrolytic solution with a polymer for gelation.

The battery main body 21 includes the external laminate packaging body 23 and the battery element 22. The battery main body 21 is shaped generally like a rectangular parallelepiped with an upper portion 21-3 having one of main faces, a lower portion 21-4 having the other main face, the end portion 21-1 having an end face, a rear end portion 21-2 (see FIG. 4) positioned opposite the end portion 21-1, and two side portions 21-5, 21-6 (see FIG. 4). The battery main body 21 has a structure where the two output sections 21-1-1, 21-1-1 project side by side out of the end portion 21-1. Specifically, the output sections 21-1-1, 21-1-1, connected to the respective electrodes of the battery element 22, are drawn out of the end portion 21-1 of the battery main body 21 to the outside of the external laminate packaging body 23. W1 in FIG. 4 denotes the width of the battery main body. H1 in FIG. 6A to 6B denote the thickness of the battery main body 21.

Referring to FIG. 6A to 6B, the circuit board 24 is composed at least primarily of, for example, an epoxy resin and shaped generally like a plate. The circuit board 24 includes electronic components as a protection circuit for controlling charge/discharge current for the battery element 22 and detecting the temperature and excess current of the battery element 22 to block current. The circuit board 24 has the mounting surface 24-1 carrying, for example, electronic components mounted thereon. The longer side of the circuit board 24 in FIG. 4 has a length (W2) that is shorter or equal to the width (W1) of the battery main body 21. The circuit board 24 is connected to the output sections 21-1-1, 21-1-1 of the battery main body 21 via the wiring 26. In FIG. 6A to 6B, 24-2 denotes a side portion on the longer side of the circuit board 24, and 24-3 denotes a side portion on the shorter side of the circuit board 24.

Referring to FIG. 6A to 6B, the holder section 25 holds the circuit board 24 in such a manner that when the battery main body 21 is displaced into contact with the circuit board 24, the circuit board 24 is displaced in accordance with the displacement of the battery main body 21. Specifically, the holder section 25 has the tapered surface 25-1-1 formed by tapering one of sides of a quadrilateral. The circuit board 24 is provided on the tapered surface 25-1-1 of the holder section 25. The holder section 25, holding the circuit board 24, is disposed close to the end portion 21-1 of the battery main body 21. An obtuse angle is made by the mounting surface 24-1 of the circuit board 24 on the holder section 25 and the end face of the vertical end portion 21-1 of the battery main body 21. The height (H2) of that side of the holder section 25 which faces the end portion 21-1 of the battery main body 21 shown in FIG. 6B is lower than the thickness (H1) of the battery main body 21. In FIG. 6B, 25-1 denotes the upper wall constituted by the tapered surface 25-1-1, 25-2 denotes a sidewall of the holder section 25 facing the end portion 21-1 of the battery main body 21, 25-3 denotes a sidewall positioned opposite a sidewall 25-2 of the holder section 25, 25-4 and 25-5 denote the respective left and right sidewalls of the holder section 25 respectively, and 25-6 denotes the bottom wall of the holder section 25.

The adhesive film 28 secures, for example, the battery main body 21, the circuit board 24, the holder section 25, and the wiring 26 in an integral manner. The adhesive film 28 is composed at least primarily of an adhesive thin film. The adhesive film 28 is attached at least to the region indicated by a dash-dot line in FIGS. 4 and 5, to secure, for example, the battery main body 21, the circuit board 24, and the holder section 25 of the battery pack 10.

The battery pack 10 may additionally include a flexible printed wiring board 27 (hereinafter, an “FPC” or flexible printed circuit) electrically connected to the main circuit board 6. The FPC 27 is extended from the circuit board 24 on the upper end of the battery main body 21 and is spread and shaped like a letter L. The FPC 27 includes, on a distal end thereof, a connecting section 27-1 electrically connected to a connector (not shown) on the main circuit board 6.

Referring to FIGS. 2 and 3, the battery pack 10 is placed into the battery enclosure 4 of the housing 2. Next, the display unit 3 (see FIG. 1) is disposed before the battery pack 10, to construct the smartphone 1.

FIG. 7 is a schematic side view of changes caused by external impact in a circuit board of the battery pack. FIG. 7 schematically shows only the battery main body, the circuit board, and the holder section of the battery pack by omitting wiring and films.

Referring to FIG. 7, the battery pack 10 in the stationary state receives an impact (P) on the rear end portion 21-2 of the battery main body 21. The battery main body 21 is displaced toward the circuit board 24 and the holder section 25. As the circuit board 24 is displaced into contact with an end face of the end portion 21-1 of the battery main body 21, the circuit board 24 on the tapered surface 25-1-1 of the holder section 25 is acted on by a force (P2) acting perpendicular to the mounting surface 24-1. This mechanism moves the circuit board 24, disposed obliquely on the holder section 25, away from the end face of the end portion 21-1 of the battery main body 21 under the impact, thereby advantageously preventing the circuit board 24 from seriously damaging the battery main body 21.

In the battery pack 10, since the circuit board 24 is disposed obliquely on the holder section 25, the length L (see FIG. 4) can be reduced that is a sum of the total length (L1, see FIG. 4) of the battery main body 21 and the length (L2, see FIG. 4) of the shorter side of the circuit board 24.

Furthermore, in the smartphone 1 equipped with the battery pack 10 described above, an impact caused, for example, by a fall of the smartphone 1 is transferred to the battery pack 10 in the housing, and the circuit board 24, disposed obliquely on the holder section 25, is moved away from an end face of the end portion 21-1 of the battery main body 21. This motion further prevents the circuit board 24 from seriously damaging the battery main body 21, thereby eliminating the risk of breaking the battery pack 10 due to such damage and for other like causes. The smartphone 1 can be hence used in a good condition for an extended period of time. In addition, in the smartphone 1, since the circuit board 24 is disposed obliquely on the holder section 25, the battery pack 10 has a reduced total length, and the left-right partitioning bodies 14, 15 of the battery enclosure 4 of the housing 2 have a reduced length. The smartphone 1 can be hence reduced in size.

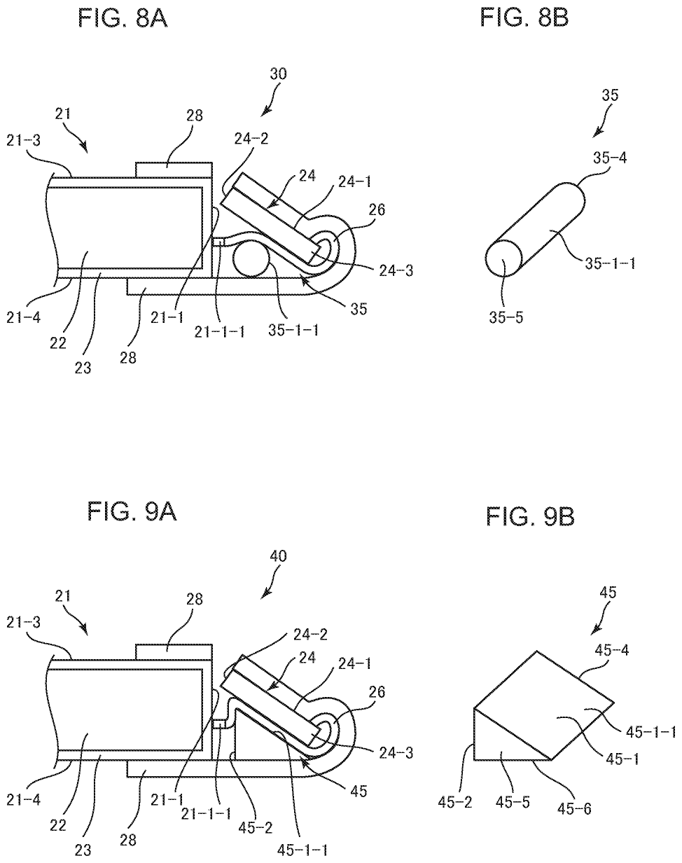

FIGS. 8 to 10 show variation examples of the battery pack and the holder section, which will be described in the following with reference to the figures. Those components having the same structure as those in the battery pack in accordance with the embodiment described above are indicated by the same reference numerals throughout the following description, and redundant description thereof is omitted.

### Variation Example 1

A description will be given of Variation Example 1 of the battery pack. FIG. 8A is a cross-sectional view of major components of a battery pack in accordance with Variation Example 1, and FIG. 8B is a perspective view of a holder section in accordance with Variation Example 1.

Referring to FIG. 8A, a battery pack 30 differs from the foregoing embodiment in that a generally cylindrical holder section 35 is used. The battery pack 30 is arranged in such a manner that the circuit board 24 is obliquely disposed on an outer circumferential surface 35-1-1 of the holder section 35. The holder section 35 has, for example, a circular cross section. In addition, the obliquely positioned circuit board 24 and the holder section 35 are disposed on the end portion 21-1 of the battery main body 21. The adhesive film 28 is used for securing such a structure and arrangement.

Referring to FIG. 8B, the holder section 35 is, for example, cylindrical and when used, laid laterally. This structure achieves advantages similar to those achieved in the foregoing embodiment. Additionally, the use of the generally cylindrical holder section 35 allows for adjustment in securing the inclination of the circuit board 24 on the holder section 35 using the adhesive film 28. Reference numerals 35-4 and 35-5 in FIG. 8B denote the circular sidewalls of the holder section 35. FIG. 8B depicts the holder section 35 as being circular in a side view. Alternatively, the holder section 35 may be elliptical in a side view.

### Variation Example 2

A description will be given of Variation Example 2 of the battery pack. FIG. 9A is a cross-sectional view of major components of a battery pack in accordance with Variation Example 2, and FIG. 9B is a perspective view of a holder section in accordance with Variation Example 2.

Referring to FIG. 9A, a battery pack 40 differs from the foregoing embodiment in that a generally triangular prismatic holder section 45 is used. The battery pack 40 is arranged in such a manner that the circuit board 24 is obliquely disposed on an outer circumferential surface of the holder section 45. The holder section 45 has, for example, a right triangular cross section. In addition, the obliquely positioned circuit board 24 and the holder section 45 are disposed opposite the end portion 21-1 of the battery main body 21. The adhesive film 28 is used for securing such a structure and arrangement.

Referring to FIG. 9B, the holder section 45 is, for example, triangular prismatic and when used, laid laterally. This structure achieves advantages similar to those achieved in the foregoing embodiment. In FIG. 9B, 45-1 denotes the upper wall constituted by a tapered surface 45-1-1, 45-2 denotes a sidewall of the holder section 45 facing the end portion 21-1 of the battery main body 21, 45-4 and 45-5 denote the respective left and right sidewalls of the holder section 45, and 45-6 denotes the bottom wall of the holder section 45.

### Variation Example 3

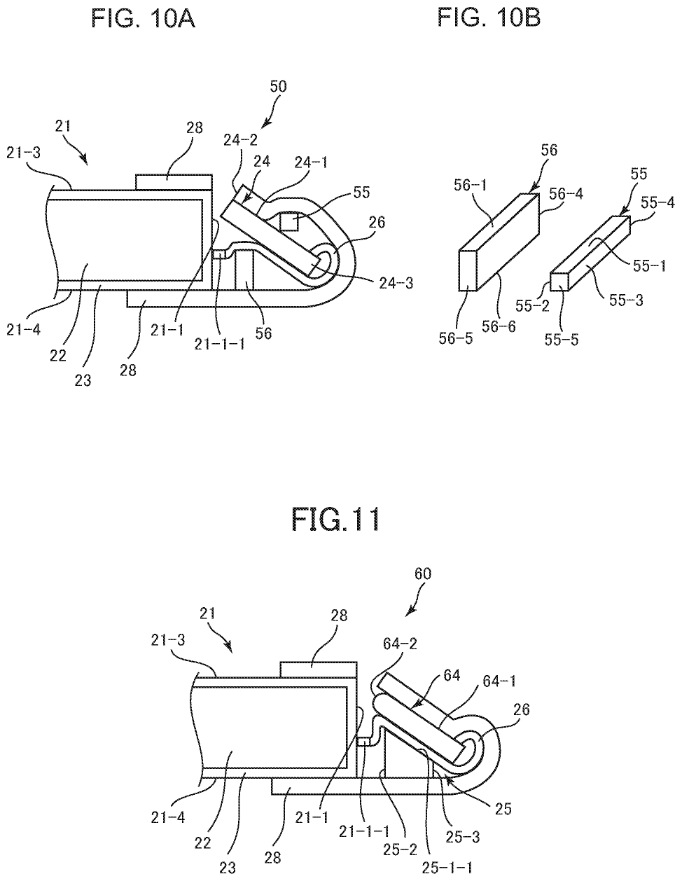

A description will be given of Variation Example 3 of the battery pack. FIG. 10A is a cross-sectional view of major components of a battery pack in accordance with Variation Example 3, and FIG. 10B is a perspective view of a holder section in accordance with Variation Example 3.

Referring to FIG. 10A, a battery pack 50 differs from the foregoing embodiment in that a plurality of holder sections 55, 56 is used. The battery pack 50 is arranged in such a manner that the circuit board 24 is obliquely disposed between the upper holder section 55 and the lower holder section 56. The upper holder section 55 and the lower holder section 56 are, for example, quadrangular prismatic. The obliquely positioned circuit board 24, the upper holder section 55, and the lower holder section 56 are disposed on the end portion 21-1 of the battery main body 21. The adhesive film 28 is used for securing such a structure and arrangement.

Referring to FIG. 10B, the upper holder section 55 and the lower holder section 56 are, for example, quadrangular prismatic and when used, laid laterally. This structure achieves advantages similar to those achieved in the foregoing embodiment. In addition, in the battery pack 50, even when the battery pack 50 receives an impact as shown in FIG. 7, the circuit board 24, obliquely placed between the upper and lower holder sections 55, 56, is moved away from an end face of the end portion 21-1 of the battery main body 21, thereby advantageously preventing the circuit board 24 from seriously damaging the battery main body 21. In other words, even when the battery pack 50 receives an impact other than impact P1 from the display unit side or from the side opposite the display unit, both the holder sections 55, 56 hold the circuit board 24, thereby further distributing damage. In FIG. 10B, 55-1 denotes the upper wall of the upper holder section 55, 55-2 denotes a sidewall of the upper holder section 55 facing the end portion 21-1 of the battery main body 21, 55-3 denotes a sidewall positioned opposite a sidewall 55-2 of the upper holder section 55, 55-4 and 55-5 denote the respective left and right sidewalls of the upper holder section 55, and 55-6 denotes the bottom wall of the upper holder section 55. In addition, 56-1 denotes the upper wall of the lower holder section 56, 56-2 denotes a sidewall of the lower holder section 56 facing the end portion 21-1 of the battery main body 21, 56-3 denotes a sidewall positioned opposite a sidewall 56-2 of the lower holder section 56, 56-4 and 56-5 denote the respective left and right sidewalls of the lower holder section 56, and 56-6 denotes the bottom wall of the lower holder section 56.

The holder section(s) may have an exterior that is shaped like a polygonal prism with four or more side faces so long as the holder section(s) can obliquely hold the circuit board.

### Additional Example

A description will be given of an additional example of the battery pack. FIG. 11 is a cross-sectional view of another battery pack.

Referring to FIG. 11, a battery pack 60 differs from the foregoing embodiment in that an edge-chamfered circuit board 64 is used. The circuit board 64 of the battery pack 60 has, on a longer side thereof, a side portion 64-2 that is, for example, edge-chamfered. This structure causes the edge-chamfered side portion of the circuit board 64 to be pushed up along the end portion 21-1 of the battery main body 21 when the battery pack 60 is placed under stress due to an external impact. The chamfering of the edge of the side portion 64-2 of the circuit board 64 hence reduces the impact of the circuit board 64 on the end portion 21-1 of the battery main body 21. Reference numeral 64-1 in FIG. 11 denotes a mounting surface of the circuit board 64.

The battery packs in accordance with the variation examples and the additional example are applicable to smartphones. Such smartphones achieve advantages similar to those achieved in the foregoing embodiment. Redundant description is omitted.

The foregoing embodiment described the electronic apparatus as being a smartphone (mobile phone). The electronic apparatus may alternatively be a tablet terminal, a personal computer, an electronic dictionary, a calculator, a gaming machine, a PHS, a PDA, or a mobile tool. As further alternatives, the electronic apparatus may be a compact display device, a television monitor, a Blu-Ray® disc recorder, or a DVD recorder.

While there have been described what are at present considered to be certain embodiments of the invention, it will be understood that various modifications may be made thereto, and it is intended that the appended claim cover all such modifications as fall within the true spirit and scope of the invention.

What is claimed is:

1. A battery pack comprising:
a battery main body including a battery element and an external laminate packaging body packaging the battery element, the battery main body having two opposing main faces and an end face connecting the two opposing main faces;
a circuit board disposed external to the end face and electrically connected to the battery main body; and
at least one holder section configured to hold the circuit board, wherein
the circuit board has an electronic component mounting surface inclined with respect to the two opposing main faces in a cross section of the battery main body taken parallel to a plane perpendicular to the two opposing main faces.

2. The battery pack according to claim 1, wherein the at least one holder section holds the circuit board in such a manner that when the battery main body is displaced into contact with the circuit board, the circuit board is displaced in accordance with the displacement of the battery main body.

3. The battery pack according to claim 1, further comprising a film configured to secure the battery main body, the circuit board, and the at least one holder section.

4. The battery pack according to claim 1, wherein the at least one holder section comprises a plurality of holder sections.

5. An electronic apparatus comprising:
the battery pack according to claim 1; and
a housing including a battery enclosure configured to enclose the battery pack.
